(19) United States
(12) Patent Application Publication
(10) Pub. No.: US 2022/0024180 A1
(43) Pub. Date: Jan. 27, 2022

(54) Fiber Polymer Composite Laminate

(71) Applicant: Tundra Composites, LLC, White Bear Lake, MN (US)

(72) Inventors: Adam Bartel, St. Paul, MN (US); Scott Bohnen, Stillwater, MN (US); Kurt Heikkila, Marine on the Saint Croix, MN (US); Michael Deaner, Osceloa, WI (US)

(73) Assignee: Tundra Composites, LLC, White Bear Lake, MN (US)

(21) Appl. No.: 17/299,894

(22) PCT Filed: Dec. 9, 2019
(86) PCT No.: PCT/US2019/065107

§ 371 Date: Jun. 4, 2021

Related U.S. Application Data
(60) Provisional application No. 62/776,563, filed on Dec. 7, 2018.

(51) Int. Cl. B32B 7/03; B32B 1/00; B32B 27/12; B32B 27/30

(52) U.S. Cl. CPC B32B 7/03; B32B 1/00; B32B 27/12; B32B 27/304; B29C 65/08; B32B 2260/046; B32B 2262/101; B32B 2262/106; B32B 2260/023

(57) ABSTRACT

A useful composite layer can be a single layer composite of fiber lengths dispersed in a polymer. A useful laminate composite can have a minimum structure of three or more layers. The laminate can have a center layer combined with two outside single layers.

### FIELD

Disclosed is a single layer of substantially parallel glass fiber in a polymer composite. A laminate of two or more layers of the composite of a polymer and linear reinforcing fibers is disclosed. These layers can be combined with other optional layers. The composite has improved processing characteristics, improved structural product properties that produce enhanced products. The novel properties are produced in the laminate and composite by novel interactions of the fiber components and polymer components.

### BACKGROUND

Substantial attention has been paid to the creation of composite materials with unique properties. Fiber used in and fabric reinforced polymer materials can include cellulosic fiber, high modulus polyolefin fiber, polybenzoxazole fiber, carbon fiber, aramid fiber, boron fiber, glass fiber and hybrid materials. The fiber can be used in reinforcing thermoplastics and thermosets. Epoxy and polyurethane thermosets are common. Polyolefin, polyvinyl chloride (PVC) and other thermoplastics and hybrids have been developed for a variety of end uses.

Developing thermoplastic polymer laminate composite materials have faced difficult barriers. Laminates can suffer from structural, strength and impact deficits. To obtain significant impact properties, thermal processing, tensile strength, modulus, and coefficient of thermal expansion (COTE) properties, a laminate composite needs to control the degree of interaction between layers of reinforcing particulate, fiber and polymer and the degree of fiber loading in the polymer matrix.

Highly filled composite materials cannot be easily made. Melt thermoplastics and fibers are not easily combined due to differences in the polymer with respect to polymer or fiber character such as composition, density, surface energy and morphology. Excessive compounding processing to obtain a uniform composite can cause fiber damage and thermal depolymerization of the polymer with accompanying hazards of fire and toxic gasses. Composites and polymer and other layers can be made but often have strength, structural, impact or delamination deficits.

In the past, the common laminates have suffered delamination at stress points or stress lines during use or processing. This can lead to cosmetic problems and structural failure.

While a substantial amount of work has been done regarding fiber reinforced thermoplastic polymer composite materials. A substantial need exists for a composite and a laminated or laminate composite material that has improved impact strength, stiffness and resistance to delamination at stress points and lines to produce laminate composites with improved structural properties at ambient and elevated use temperatures.

### BRIEF DESCRIPTION

A useful polymer glass fiber composite can be a single layer of substantially parallel fibers dispersed in polymer.

A laminate composite web or tape product can have a two or more layers.

Each layer is a dispersion of separate fibers from a glass roving in a horizontal array of substantially parallel fibers, the fibers are dispersed in the polymer. The roving having many individual fibers, are coated with an interfacial modifier. The roving is separated into a horizontal and substantially uniform distribution of substantially parallel separated fiber. The fiber distribution is then contacted with polymer in a melt (thermoplastic) process coating that disperses the fiber into the polymer phase. The single layer product is a thin web of substantially parallel and continuous fiber dispersed in a continuous polymer layer.

A useful product laminate can have a minimum of two layers of the composite optionally combined with other two other interior or exterior layers. The laminate can have a layer of the single layer web and at least one substrate. Each adjacent layer can be made with the direction of the fiber in a layer placed at a 90° angle to the adjacent layer. In multiple layer laminates each layer can alternate fiber direction. The interfacially modified fiber composite is combined with a layer comprising a polymer layer or a polymer composite layer.

An aspect of the claimed material is thin substantially planar single layer composite with a substantially parallel distribution of interfacially modified fibers dispersed in a thermoplastic matrix or phase. This composite can take the form of a flexible high tensile tape that can be stored on a reel or spool or other such storage unit for use in manufacture of a structural article.

An aspect of the claimed laminate is a combination of two or more layers of the single layer material and a third layer comprising a particulate or chopped fiber polymer composite.

Another aspect is a structural laminate of two or more layers of the claimed material wherein at least one layer has fibers positioned at right angles to the fiber in another layer of the laminate. Preferably the layers are adjacent but can be separate by other optional layers.

Another aspect is a structural member made of the laminate composite. Such structural members can be used in any structural application such as residential or commercial real estate. Examples of the member are an I-beam, a C-channel, a hollow or solid rod like member with any arbitrary cross-section such as a circle, oval, ellipse square, rectangle, etc. can include such products as extension or step ladders, commercial and residential construction and can include framing members, solid laminate beams, siding and fenestration units including decking, trim, windows and doors. The laminate composition of the embodiment has the following mechanical characteristics: high tensile modulus, high flexural modulus, high tear strength, high burst strength, high abrasion resistance and high impact resistance. These embodiments can be used in both extension and step ladders with the assembly of the ladder using either welding or riveting construction techniques. The tape embodiment discussed above can have the following dimensions, about 0.1 to 1 millimeter in thickness and indeterminate length, and a width greater than one inch that can be to 12 inches, 3 to 10 inches, or 4 to 6 inches.

Another aspect of the claimed material is a method of forming a composite.

Another aspect of the claimed material is a method of forming a laminate.

The term “fiber” means a collection of similar fibers. The fiber can be used as a component of a fiber or as a collection of discrete fibers in a fibrous material combined with a polymer as input to a compounding process unit. The term “fiber” as used in a discontinuous phase can be free of a particle or the fabric layer can be a woven or non-woven fabric. The polymer can be a thermoplastic material. The polymer composite can combine a polymer with dispersed phase such as a fabric, fiber or a particulate.

The term “fabric” as used in this disclosure means either a woven or non-woven material made of a fiber.

The term “roving” or “fiberglass roving” means a collection of 100 to 10,000 individual glass fibers in a compact yarn or bundle. A “roving” is typically made by extruding the individual fibers from a melt through a die with a corresponding number of small apertures to the fibers made. The fibers are gathered and wound onto a storage roll or bobbin. A “roving” can contain fiber from one, two or more dies.

The term “tape” means a thin flexible sheet or web having a width substantially greater than its thickness and an inseminate length. One attribute of a “tape” is its capacity to be used in or on rolls or spools when taken to be combined in a useful article.

The term “joint” means the joinder of a horizontal with a vertical member and can contain two or more welds.

“Polymeric or polymer layer” means a layer that contains at least a continuous polymer layer and can also contain a particulate and a fiber or both.

A “weld” is a bonding area comprising melted and then cooled thermoplastic from both joined members.

The term “Polymer composite” can be formed into a layer and the layer contains at least a continuous polymer and a fiber or fibers.

The term “web” means a sheet like structure having a width substantially greater than its thickness and an indeterminate length. Such a web can include tape like products and discrete sheets useful in lamination processes.

The term “indeterminate length” means a length dimension that can be arbitrary and is selected as needed for any continuous or batch type process or product application. Such length cannot be infinite but is selected for each selection of product storage or end use or product type. For example, an adhesive tape of indeterminate length can be made with a fixed thickness and width but can be packaged on a dispensing roll in a length that can be practically fit into the dispenser and then used in a manufacture.

The term “continuous phase” means the polymer matrix into which the fiber is dispersed during compounding.

“Discontinuous phase” means the individual fibers that are dispersed throughout the continuous phase.

The term “machine direction” refers to the direction that an extrudate exits the extruder. This is parallel to the extruder screw rotational axis and the polymer direction of flow through the extruder.

“Cross machine direction” is a direction at 90° angle to the machine direction.

The term “interfacial modifier” (IM) means a material that can coat the surface of particulate, fiber, fabric and does not react or interact with the polymer or other coated material present in the composite. In one embodiment, the IM is an organo-metallic compound.

### BRIEF DESCRIPTION OF THE FIGURES

FIG. 1 is a cross sectional view of an extruded hollow profile structural member. The member can be an interior or exterior component.

FIG. 2 shows a cross sectional view of an extruded C shaped structural member profile.

FIG. 3 is a plan view of a photograph of a portion of an extruded layer of a polymer and indeterminately long and parallel glass fibers embedded therein.

FIG. 4 is a plan view of a photograph of a portion of an article comprising two laminated layers of an extruded layer like that of FIG. 3.

### DETAILED DISCUSSION

Composites of the embodiments are made by combining an interfacially modified or coated fiber with a polymer. Laminates are made by assembling at least two layers of the composite. The laminate can achieve novel physical and process properties including enhanced impact.

The claimed material is made from a collection of substantially parallel fibers such as a yarn or tow. A multiplicity of substantially continuous, unentangled, parallel, structural glass fibers, each oriented in substantially parallel direction. The filaments are arranged horizontally across a web in an even dispersion and are then embedded or formed as a discontinuous phase within a continuous thermoplastic material phase. Across the width of the material the distribution of glass fibers should be optimized as a uniform distribution, however, due to manufacturing inconsistencies, the distributions may be not entirely uniform but can have localized areas of increased fiber concentrations. In the composite the desired properties of the final composite material will be achieved when the fibers are optimized in uniformity and are substantially parallel within the composite structure. The fiber is derived from a plurality of threads, one or more yarns or one or more tows as those terms are understood in the industry. A plurality of individual fibers is sorted, uniformly spread and then dispersed into a polymer in a parallel distribution, array or arrangement. The fibers are directed through an extruder head and is combined with polymer in the melt phase to form a layer of fiber coated by or dispersed in polymer. The layer contains parallel and continuous lengths of fiber in a layer having a thickness substantial less than its width made in indeterminate or arbitrary lengths.

The fiber, yarn, or tow reinforcing material of the claimed composite can comprise any inorganic or organic yarn, fiber, or tow that exhibits substantial tensile strength in the fiber and substantial physical properties in the composite even at elevated temperatures. Such fibers, yarns, or tows are substantially multi-filament assemblies of fibers having 500 or more fibers and can have up to 20,000 fibers. Such yarns or fibers are typically produced by heating precursor material into a melt and then spinning the fibers through small diameter orifices. The spun fibers can then be taken up with spools, bobbins, reels, or other form that can contain a large indeterminate length or quantity of the manufactured fiber. The specific choice of the fiber is governed by the environment of the intended use. In applications strength, stiffness, impact strength, and toughness can be engineered for each individual use. For example, an extension ladder can have extended linear members separated by treads. Extension ladders can also contain smaller molded structures. Each of these applications have different structural requirements which can be engineered as needed. The properties can be obtained by varying the fiber content, fiber diameter, composite, and dimensions and polymer or thermoplastic content. Further, the type of fiber can have a significant impact on the ultimate physical properties of the composite. Useful fibers include natural and synthetic fibers. Natural fibers include cellulosics, such as wood fibers and cotton and proteins such as wool or silk. Synthetic fibers include inorganic and organic materials. Inorganic include ceramics, carbon, metals and glass fibers. Organic fibers are typically polymeric materials such as acrylics, polyester, nylon, polyolefin etc.

The glass fiber is particularly useful in manufacturing the composites in the invention are compatible with the thermoplastic material in the sense that they are chemically inert and have surface characteristics that do not prevent wet out of the polymer onto the glass surface. Further, the fiber material should have a coefficient of thermal expansion that is not substantially dissimilar from the polymer matrix.

In making the composite as claimed, the reinforcing fiber tow or yarn is typically dispersed within a thermoplastic matrix at a volume fraction of about 5-10, or 5-20, or 5-30, or 5-40, or 5-50 volume percent. These proportions are set to obtain the desired properties in the composite as required by the end use of the composite material. The composite as claimed can be in the form of a flexible tape that has an indeterminate length, and a width substantially greater than thickness. In this aspect the indeterminate length can refer to any length that can be stored on a reel or spool or other storage unit that can be used in article fabrication. The properties needed in this composite are tensile strength in the direction parallel to the direction of the unidirectional fibers, flexibility and sufficient thermoplastic character to be successfully used in a heated lamination process to make a structural article.

In certain applications of the composite materials, the primary properties contributing to a final structural article can include impact resistance, stiffness, and the ability to adapt the composite to the specific structural characteristics of the final product containing multiple parts made from the composite. Such parts can be combined using a variety of mechanical, adhesive, and thermal construction techniques. The composites of the claimed materials begin with processing a plurality of the fiber from a tow or yarn, preparing the fiber tow or yarn in an arrangement of the fibers in a longitudinal substantially planar array, combining the substantially longitudinal planar and parallel array with a thermoplastic material to form a substantially uniform web of parallel fibers dispersed in a polymer matrix.

As used in this disclosure the term “interfacial modifier” (IM) means a material that can coat the surface of fiber and does not react or interact with the polymer or other coated fiber present in the composite.

As used in this disclosure the term “densified” when used as a composite fiber material characteristic means a fiber source that is processed to increase the bulk density of the material such that is approaches the density of the polymer used in the composite. A silicate fiber that is naturally about 0.2 to 0.4 g-cm³ density is processed to have an increased density, a minimal increase can be useful but a greater increase such as at least 10% or at least 20% can provide useful properties. A fiber source that is processed to increase the bulk density of the material such that is approaches the density of the polymer used in the composite. A silicate fiber that is naturally about 0.2 to 0.4 g-cc⁻³ density is processed and densified to be at least 0.5 g-cc⁻³ or more. Typically, silica as found in glass is not a silicate. Silica composition is typically species as SiO₂. A silicate is typically one or more individual species as a salt of a charged silicate anion such as SiO₃⁺² or SiO₄⁺⁴ or other charged similar silicate species.

The fiberglass fiber useful as reinforcing fiber includes several commercially available types of fiberglass, e.g. types of fiberglass, e.g types A, C, D, E, Zero Boron E, ECR, AR, R, S, S-2, N, and the like. These fibers are characterized in having a tensile modulus enough to act as a structural component, Many have a tensile modulus in the range of from 10-14×10⁶ psi or more if necessary, and an elongation at break of not greater than about 3%. The fiber is typically in the form of a collection of individual threads, a multi-fiber yarn or tow. The fiber is obtained in large units and often comes as a wrapped fiber in a spool or other form.

The laminate possesses the following superior properties as compared to conventional fiber reinforced laminate: (1) increased load carrying under flexure, (2) less deflection, (3) resistance to delamination, and (4) greater Izod impact load.

The interfacial modified fabric layer is combined with a polymer layer or a fiber composite layer, a particulate composite layer or a composite of a combination of fiber particulate and polymer. Any reinforcing fiber can be used including cellulosic, glass, polymer, carbon, etc. A useful fiber comprises a silica fiber and a silicate fiber. The composite can be made of about 10 to 90 wt. % of a continuous phase comprising the polymer with about 5 to 95 wt. % or about 90 to 10 wt. % of a discontinuous s phase comprising the glass fiber.

Each of the individual fibers of the silicate fiber material has a cross-section dimension (preferably but not limited to a diameter) of at least about 0.8 micron often about 1-150 microns and can be 2-100 microns a length of 0.1-150 mm, often 0.2-100 mm, and often 0.3-20 mm and can have an aspect ratio of at least 90 often about 100-1500. These aspect ratios are typical if the input is to the compounder. After pellets are formed the aspect ratio is set by the pellet dimensions.

Silica forms another useful fiber and comprises a glass fiber known by the designations: A, C, D, E, Zero Boron E, ECR, AR, R, S, S-2, N, and the like. Generally, any glass that can be made into fibers either by drawing processes used for making reinforcement fibers or spinning processes used for making thermal insulation fibers. Such fiber is typically used as a length of about 0.8-100 mm often about 2-100 mm, a diameter about 0.8-100 microns and an aspect ratio (length divided by diameter) greater than 90 or about 100 to 1500. These commercially available fibers are often combined with a sizing coating. Such coatings cause the otherwise ionically neutral glass fibers to form and remain in bundles or fiber aggregates. Sizing coatings are applied during manufacture before gathering. The sizing minimizes filament degradation caused by filament to filament abrasion. Sizings can be lubricants, or reactive couplers but do not act as an interfacial modifier or contribute to the properties of a composite using an interfacial modifier (IM) coating on the fiber surface. The glass fibers employed in the embodiments include glass fibers available commercially. The fibers may be either woven, knitted or nonwoven. Glass can comprise at least 50 wt. % of the total weight of the layered or laminated structure. The fiber composition of the laminate or layers may comprise a porous glass fiber of woven, nonwoven, or knitted construction coated on one side with a thermoplastic polymer. On the obverse side, a layer of the polymer is associated, but not bonded, to the base glass fiber layer. More than one layer of thermoplastic polymer may be applied, and the temperatures adjusted to embed the polymer to the underlying and/or the overlying glass fiber layer. After polymer application, the entire fiber and polymer two-layer construction is subjected to a heat compression enough to cause the polymer to be compressed into the interstices of the glass fiber layers whereby the fibers at least

Novel laminate composites can also be made by combining an interfacial modified fabric with other layers comprising a polymer or polymer composite. The reinforcing fabrics are usually employed in the form of woven or nonwoven mats and that many different types of weaves may be used. For example, plain, twill, long shaft satin, plain satin, basket, unidirectional and mock-leno are representative weaves for these reinforcing layer fibers. Also, these fibers may be used in non-woven form such as a chopped strand or continuous strand mat. For example, a fiberglass chopped strand mat is commonly employed in the preparation of fiberglass reinforced laminates. The woven or nonwoven can be combined with a bonding agent to enhance fabric integrity.

Fabric in the form of a woven or non-woven can be formed from a variety of conventional fibers including cellulosic fibers such as cotton, hemp or other natural fibers, inorganic fibers including glass, fiberglass fibers or organic fibers such as polyester polymers, nylon polymers, or other conventional fibers or polymeric, materials. In woven fabric, the fibers are typically formed into an interlocking mesh of warp and weft fiber in a typical woven format. Non-woven fabrics are typically made by forming loosely the fibers in no important direction or orientation and then binding the fibers into a fabric.

A composite is more than a simple admixture with properties that can be predicted by the rule of mixtures. A composite is defined as a combination of two or more substances at various percentages, in which each component results in properties that are in addition to or superior to those of its constituents. In a simple admixture, the mixed material has little interaction and little property enhancement. In a composite material, at least one of the materials is chosen to increase stiffness, strength or density. The atoms and molecules in the components of the composite can form bonds with other atoms or molecules using several mechanisms. Such bonding can occur between the electron cloud of an atom or molecular surfaces including molecular-molecular interactions, atom-molecular interactions and atom-atom interactions. Each bonding mechanism involves characteristic forces and dimensions between the atomic centers even in molecular interactions. In the composites of the claimed materials strong covalent or ionic bonding is avoided. Reactive coupling agents that bond polymer to fiber are not used. The composite is formed with van der Waals bonding as modified by the IM coating.

In the IM modified van der Waals composite materials, we have found that the unique combination of fiber, the varying but controlled size and aspect ratio of the fiber component, the modification of the interaction between the fiber and the polymer, result in the creation of a unique van der Waals' bonding. The van der Waals' forces arise between molecules/aggregates/crystals and are created by the combination of fiber size, polymer and interfacial modifiers in the composite.

In the past, materials have been made as mere mixtures of components or as covalently or reactively coupled components. While these are often characterized, as “composite”, they are stiff inextensible materials or merely comprised a polymer filled with fiber with little or no van der Waals' interaction between the fiber filler material. In sharp contrast to the previous materials, the embodiments of the application show that the interaction between the selection of fiber size distribution and interfacially modified fiber enables the fiber to achieve an intermolecular distance that creates a substantial van der Waals' bonding.

The reference materials having little viscoelastic properties, do not achieve a true composite structure as is now described. This leads us to conclude that this intermolecular distance is not attained in the prior art. In the discussion above, the term “molecule” can be used to relate to a fiber, a fiber comprising non-metal crystal or an amorphous aggregate, other molecular or atomic units or sub-units of non-metal or inorganic mixtures. The van der Waals' forces occur between collections of metal atoms, embodiments of the interfacial modifier, that act as “molecules”.

This characterized by a composite having intermolecular forces between fibers less than about 30 kJ-mol⁻¹ and a bond dimension of 3-10 Å. The fiber in the composite, the reinforcement, is usually much stronger and stiffer than the matrix, and gives the composite its good properties in, for example a shaped article, structural member or other end use. The matrix holds the reinforcements in an orderly high-density pattern. Because the reinforcements are usually discontinuous, the matrix also helps to transfer load among the reinforcements. Processing can aid in the mixing and filling of the reinforcement or fiber. To aid in the mixture, an interfacial modifier can help to overcome the forces that prevent the matrix from forming a substantially continuous phase of the composite. The composite properties arise from the intimate, close association of interfacially modified fiber and polymer obtained by use of careful processing and manufacture.

In an embodiment, both fibers are typically coated with an interfacial surface chemical treatment also called an interfacial modifier (IM) that supports or enhances the final properties of the composite such as viscoelasticity, rheology, high packing fraction, and fiber surface inertness. These properties are not present in contemporary composite or mixed materials. The fibers can be coated separately or the fibers can be combined and then coated. An interfacially modified fiber has a substantially complete coating of an interfacial modifier (IM) with a thickness of less than 1000 Angstroms often less than 200 Angstroms, and commonly 10 to 500 Angstroms (Å).

An interfacial modifier is an organo-metallic material that provides an exterior coating on the fiber promoting the close association, but not attachment or bonding, of polymer to fiber and fiber to fiber. The composite properties arise from the intimate, close association of the polymer and fiber obtained by use of careful processing and manufacture. An interfacial modifier is an organic material, in some examples an organo-metallic material, that provides an exterior coating on the fiber to provide a surface that can associate with the polymer promoting the close association of polymer and fiber but with no reactive bonding, such as covalent bonding for example, of polymer to fiber, fiber to fiber, or fiber to a different particulate, such as a glass fiber or a glass bubble. The lack of reactive bonding between the components of the composite leads to the formation of the novel composite—such as high packing fraction, commercially useful rheology, viscoelastic properties, and surface inertness of the fiber. These characteristics can be readily observed when the composite with interfacially modified coated fiber is compared to fiber lacking the interfacial modifier coating. In one embodiment, the coating of interfacial modifier at least partially covers the surface of the fiber. In another embodiment, the coating of interfacial modifier continuously and uniformly covers the surface of the fiber, in a continuous coating phase layer.

Interfacial modifiers used in the application fall into broad categories including, for example, titanate compounds, zirconate compounds, hafnium compounds, samarium compounds, strontium compounds, neodymium compounds, yttrium compounds, phosphonate compounds, aluminate compounds and zinc compounds. Aluminates, phosphonates, titanates and zirconates that are useful contain from about 1 to about 3 ligands comprising hydrocarbyl phosphate esters and/or hydrocarbyl sulfonate esters and about 1 to 3 hydrocarbyl ligands which may further contain unsaturation and heteroatoms such as oxygen, nitrogen and sulfur. In embodiments, the titanates and zirconates contain from about 2 to about 3 ligands comprising hydrocarbyl phosphate esters and/or hydrocarbyl sulfonate esters, preferably 3 of such ligands and about 1 to 2 hydrocarbyl ligands, preferably 1 hydrocarbyl ligand.

In one embodiment, the interfacial modifier that can be used is a type of organo-metallic material such as organo-boron, organo-cobalt, organo-iron, organo-nickel, organo-titanate, organo-aluminate organo-strontium, organo-neodymium, organo-yttrium, organo-zinc or organo-zirconate. The specific type of organo-titanate, organo-aluminates, organo-strontium, organo-neodymium, organo-yttrium, organo-zirconates which can be used and which can be referred to as organo-metallic compounds are distinguished by the presence of at least one hydrolysable group and at least one organic moiety. Mixtures of the organo-metallic materials may be used. The mixture of the interfacial modifiers may be applied inter- or intra-fiber, which means at least one fiber may has more than one interfacial modifier coating the surface (intra), or more than one interfacial modifier coating may be applied to different fibers or fiber size distributions (inter).

Certain of these types of compounds may be defined by the following general formula:

M(R₁)ₙ(R₂)ₘ

wherein M is a central atom selected from such metals as, for example, Ti, Al, and Zr and other metal centers; R₁ is a hydrolysable group; R₂ is a group consisting of an organic moiety, preferably an organic group that is non-reactive with polymer or other film former; wherein the sum of m+n must equal the coordination number of the central atom and where n is an integer ≥1 and m is an integer ≥1. Particularly R₁ is an alkoxy group having less than 12 carbon atoms. Other useful groups are those alkoxy groups, which have less than 6 carbons, and alkoxy groups having 1-3 C atoms. R₂ is an organic group including between 6-30, preferably 10-24 carbon atoms optionally including one or more hetero atoms selected from the group consisting of N, O, S and P. R₂ is a group consisting of an organic moiety, which is not easily hydrolyzed and is often lipophilic and can be a chain of an alkyl, ether, ester, phospho-alkyl, phospho-alkyl, phospho-lipid, or phospho-amine. The phosphorus may be present as phosphate, pyrophosphato, or phosphito groups. Furthermore, R₂ may be linear, branched, cyclic, or aromatic. R₂ is substantially unreactive, i.e. not providing attachment or bonding, to other particles or fiber within the composite material. Titanates provide antioxidant properties and can modify or control cure chemistry.

The use of an interfacial modifier results in workable thermoplastic viscosity and improved structural properties in a final use such as a structural member or shaped article. Minimal amounts of the modifier can be used including about 0.005 to 8 wt.-%, about 0.01 to 6 wt.-%, about 0.02 to 5 wt.-%, or about 0.02 to 3 wt. %. The IM coating can be formed as a coating of at least 3 molecular layers or at least about 50 or about 100 to 500 or about 100 to 1000 angstroms (Å). The claimed composites with increased loadings of fiber can be safely compounded and melt processed formed into high strength structural members. The interfacial modification technology depends on the ability to isolate the fibers from the continuous polymer phase. The isolation is obtained from a continuous molecular layer(s) of interfacial modifier to be distributed over the fiber surface.

From another perspective, the IM coated fiber is immiscible in the polymer phase. Once this layer is applied, the polymer dominates and defines certain physical properties of the composite and the shaped or structural article (e.g. rheology, viscoelastic character and elongation behavior). The nature of the fiber dominates the material characteristics of the composite (e.g. density, thermal conductivity, tensile properties, compressive strength, etc.). The correlation of fiber bulk properties to that of the final composite is especially strong due to the high-volume percentage loadings of discontinuous phase, such as fiber, associated with the technology.

The current upper limit constraint is associated with challenges of successful dispersion of fibers within laboratory compounding equipment without significantly damaging the high aspect ratio fibers. Furthermore, inherent rheological challenges are associated with high aspect ratio fibers. With proper engineering, the ability to successfully compound and produce interfacially modified fibers of fiber fragments with aspect ratio more than 10 is envisioned.

In a composite, the non-metal, inorganic or mineral fiber is usually much stronger and stiffer than the matrix and gives the composite its designed properties. The matrix holds the non-metal, inorganic or mineral fibers in an orderly high-density pattern. Because the non-metal, inorganic or mineral particles are usually discontinuous, the matrix also helps to transfer load among the non-metal, inorganic or mineral fibers. Processing can aid in the mixing and filling of the non-metal, inorganic or mineral fiber. To aid in the mixture, a surface chemical coating can help to overcome the forces that prevent the mixture from forming a substantially continuous phase of the composite. The tunable composite properties arise from the intimate association obtained by use of careful processing and manufacture. We believe a surface chemical coating or interfacial modifier is an organic material that provides an exterior coating on the fiber promoting the close association of polymer and fiber. Minimal amounts of the interfacial modifier can be used including about 0.005 to 8 wt.-%, or about 0.02 to 3 wt. %. Higher amounts are used to coat materials with increased morphology.

Typically, the composite materials of the invention are manufactured using melt processing and are also utilized in product formation using melt processing. A typical thermoplastic polymer material is combined with fiber and processed until the material attains (e.g.) The fibers are coated or treated with IM before processing to obtain the ease of processing and physical properties needed. Once coated, the fiber exterior appears to be the IM composition while the fiber silica character is hidden. The organic nature of the coating changes the nature of the interaction between the fiber surface and the polymer phase. The silicate surfaces of the fibers are of a different surface energy and hydrophobicity than the polymer or coating. The polymer does not easily associate with the inorganic fiber surface, but much more easily associates with the organic nature of the coated surface of the inorganic fiber. The coated fiber mixes well with the polymer and can achieve greater composite uniformity and fiber loadings. The composite, thus, obtains improved physical properties such as notched IZOD impact strength (ft-lb-in⁻¹) (ASTM D256), tensile strength (lb-in²), modulus (lb.×10⁶-in⁻²) and elongation (%) (ASTM D638/D3039) flexural strength (lb-in²) and modulus (lb.×10⁶-in⁻²) at elevated temperature (ASTM 790), and coefficient of thermal expansion (in-in⁻¹-° C.) (COTE—ASTM 696). Such properties are seen over a range of environmental temperatures.

A large variety of thermoplastic polymer and copolymer materials can be used in the composite materials. We have found that polymer materials useful in the composite include both condensation polymeric materials and addition or vinyl polymeric materials.

Vinyl polymers are typically manufactured by the polymerization of monomers having an ethylenically unsaturated olefinic group. Condensation polymers are typically prepared by a condensation polymerization reaction which is typically considered to be a stepwise chemical reaction in which two or more molecules combined, often but not necessarily accompanied by the separation of water, methanol or some other simple, typically volatile substance. Such polymers can be formed in a process called polycondensation. The typical polymer has a density of at least 0.85 gm-cm⁻³, however, polymers having a density of greater than 0.96 are useful to enhance overall product density. A density is often 0.94 to 1.7 or up to 2 gm-cm⁻³ or can be about 0.96 to 1.95 gm-cm⁻³.

Vinyl polymers include polyacrylonitrile; polymer of alpha-olefins such as ethylene, propylene, etc.; polymers of chlorinated monomers such as vinyl chloride, vinylidene chloride, acrylate monomers such as acrylic acid, methyl acrylate, methyl methacrylate, acrylamide, hydroxyethyl acrylate, and others; styrenic monomers such as styrene, alpha-methyl styrene, vinyl toluene, etc.; vinyl acetate; and other commonly available ethylenically unsaturated monomer compositions. Examples include polyethylene, polypropylene, polybutylene, acrylonitrile-butadiene-styrene (ABS), polybutylene copolymers, polyacetal resins, polyacrylic resins, homopolymers, etc. Useful polymers are halogen polymers such as homopolymers, copolymers, and blends comprising vinyl chloride, vinylidene chloride, fluorocarbon monomers, etc. Polyvinyl chloride polymers with a K value of 50-75 can be used. A characteristic of the PVC resin is the length or size of the polymer molecules. A measure of the length or size is molecular weight of PVC. A useful molecular weight can be based on measurements of viscosity of a PVC solution. Such a K value ranges usually between 35 and 80. Low K-values imply low molecular weight (which is easy to process but has properties consistent with lower polymer size) and high K-values imply high molecular weight, (which is difficult to process, but has properties consistent with polymer size). The most commonly employed molecular characterization of PVC is to measure the one-point-solution viscosity. Expressed either as inherent viscosity (IV) or K-value, this measurement is used to select resins for the use in extrusion, molding, as well as for sheets, films or other applications. The inherent viscosity (IV) or K-value is the industry standard (ISO 1628-2) starting point for designing compounds for end use. Polymer solution viscosity is the most common measurement for further calculation of inherent viscosity or the K-value, because it is an inexpensive and routine procedure that can be used in manufacturing as well as in R&D labs. For example, a Lovis® 2000 M/ME micro-viscometer can measure polymer solution viscosity and set K value.

Condensation polymers include nylon, phenoxy resins, polyarylether such as polyphenylether, polyphenylsulfide materials; polycarbonate materials, chlorinated polyether resins, polyethersulfone resins, polyphenylene oxide resins, polysulfone resins, polyimide resins, thermoplastic urethane elastomers and many other resin materials. Condensation polymers that can be used in the composite materials include polyamides, polyamide-imide polymers, polyarylsulfones, polycarbonate, polybutylene terephthalate, polybutylene naphthalate, polyetherimides, polyether sulfones, polyethylene terephthalate, thermoplastic polyamides, polyphenylene ether blends, polyphenylene sulfide, polysulfones, thermoplastic polyurethanes and others. Preferred condensation engineering polymers include polycarbonate materials, polyphenyleneoxide materials, and polyester materials including polyethylene terephthalate, polybutylene terephthalate, polyethylene naphthalate and polybutylene naphthalate materials.

Polycarbonate engineering polymers are high performance, amorphous engineering thermoplastics having high impact strength, clarity, heat resistance and dimensional stability. Polycarbonates are generally classified as a polyester or carbonic acid with organic hydroxyl compounds. The most common polycarbonates are based on phenol A as a hydroxyl compound copolymerized with carbonic acid. Materials are often made by the reaction of a biphenyl A with phosgene (O═CCl₂). Polycarbonates can be made with phthalate monomers introduced into the polymerization extruder to improve properties such as heat resistance, further trifunctional materials can also be used to increase melt strength or extrusion blow molded materials. Polycarbonates can often be used as a versatile blending material as a component with other commercial polymers in the manufacture of alloys. Polycarbonates can be combined with polyethylene terephthalate acrylonitrile-butadiene-styrene, styrene maleic anhydride and others. Preferred alloys comprise a styrene copolymer and a polycarbonate. Preferred polycarbonate materials should have a melt index between 0.5 and 7, preferably between 1 and 5 gm./10 min.

A variety of polyester condensation polymer materials including polyethylene terephthalate, polybutylene terephthalate, polyethylene naphthalate, polybutylene naphthalate, etc. can be useful in the composites. Polyethylene terephthalate and polybutylene terephthalate are high performance condensation polymer materials. Such polymers often made by a copolymerization between a diol (ethylene glycol, 1,4-butane diol) with dimethyl terephthalate. In the polymerization of the material, the polymerization mixture is heated to high temperature resulting in the transesterification reaction releasing methanol and resulting in the formation of the engineering plastic. Similarly, polyethylene naphthalate and polybutylene naphthalate materials can be made by copolymerizing as above using as an acid source, a naphthalene dicarboxylic acid. The naphthalate thermoplastics have a higher T_{g} and higher stability at high temperature compared to the terephthalate materials. However, all these polyester materials are useful in the composite materials. Such materials have a preferred molecular weight characterized by melt flow properties. Useful polyester materials have a viscosity at 265° C. of about 500-2000 cP, preferably about 800-1300 cP

Polyphenylene oxide materials are engineering thermoplastics that are useful at temperature ranges as high as 330° C. Polyphenylene oxide has excellent mechanical properties, dimensional stability, and dielectric characteristics. Commonly, phenylene oxides are manufactured and sold as polymer alloys or blends when combined with other polymers or fiber. Polyphenylene oxide typically comprises a homopolymer of 2,6-dimethyl-1-phenol. The polymer commonly known as poly (oxy-(2,6-dimethyl-1,4-phenylene)). Polyphenylene is often used as an alloy or blend with a polyamide, typically nylon 6-6, alloys with polystyrene or high impact styrene and others. A preferred melt index (ASTM 1238) for the polyphenylene oxide material typically ranges from about 1 to 20, preferably about 5 to 10 gm./10 min. The melt viscosity is about 1000 cP at 265° C.

Another class of thermoplastic includes styrenic copolymers. The term styrenic copolymer indicates that styrene is copolymerized with a second vinyl monomer resulting in a vinyl polymer. Such materials contain at least a 5 mol.-% styrene and the balance being 1 or more other vinyl monomers. An important class of these materials is styrene acrylonitrile (SAN) polymers. SAN polymers are random amorphous linear copolymers produced by copolymerizing styrene acrylonitrile and optionally other monomers. Emulsion, suspension and continuous mass polymerization techniques have been used. SAN copolymers possess transparency, excellent thermal properties, good chemical resistance and hardness. These polymers are also characterized by their rigidity, dimensional stability and load bearing capability. Olefin modified SAN's (OSA polymer materials) and acrylic styrene acrylonitrile (ASA polymer materials) are known. These materials are somewhat softer than unmodified SAN's and are ductile, opaque, two phased terpolymers that have surprisingly improved weatherability.

ASA polymers are random amorphous terpolymers produced either by mass copolymerization or by graft copolymerization. In mass copolymerization, an acrylic monomer styrene and acrylonitrile are combined to form a heteric terpolymer. In an alternative preparation technique, styrene acrylonitrile oligomers and monomers can be grafted to an acrylic elastomer backbone. Such materials are characterized as outdoor weatherable and UV resistant products that provide excellent accommodation of color stability property retention and property stability with exterior exposure. These materials can also be blended or alloyed with a variety of other polymers including polyvinyl chloride, polycarbonate, poly methyl methacrylate and others. An important class of styrene copolymers includes the acrylonitrile-butadiene-styrene monomers. These polymers are very versatile family of engineering thermoplastics produced by copolymerizing the three monomers. Each monomer provides an important property to the final terpolymer material. The final material has excellent heat resistance, chemical resistance and surface hardness combined with processability, rigidity and strength. The polymers are also tough and impact resistant. The styrene copolymer family of polymers has a melt index that ranges from about 0.5 to 25, preferably about 0.5 to 20.

Important classes of engineering polymers that can be used include acrylic polymers. Acrylics comprise a broad array of polymers and copolymers in which the major monomeric constituents are an ester acrylate or methacrylate. These polymers are often provided in the form of hard, clear sheet or pellets. Acrylic monomers polymerized by free radical processes initiated by typically peroxides, azo compounds or radiant energy. Commercial polymer formulations are often provided in which a variety of additives are modifiers used during the polymerization provide a specific set of properties for certain applications. Pellets made for polymer grade applications are typically made either in bulk (continuous solution polymerization), followed by extrusion and pelleting or continuously by polymerization in an extruder in which unconverted monomer is removed under reduced pressure and recovered for recycling. Using methyl acrylate, methyl methacrylate, higher alkyl acrylates and other copolymerizable vinyl monomers commonly makes acrylic plastics. Preferred acrylic polymer materials useful in the composites have a melt index of about 0.5 to 50, preferably about 1 to 30 gm./10 min.

Polymer blends or polymer alloys can be useful in manufacturing the claimed pellet or linear extrudate. Such alloys typically comprise two miscible polymers blended to form a uniform composition. Scientific and commercial progress in the area of polymer blends has led to the realization that important physical property improvements can be made not by developing new polymer material but by forming miscible polymer blends or alloys. A polymer alloy at equilibrium comprises a mixture of two amorphous polymers existing as a single phase of intimately mixed segments of the two macro molecular components. Miscible amorphous polymers form glasses upon sufficient cooling and a homogeneous or miscible polymer blend exhibits a single, composition dependent glass transition temperature (T_{g}). Immiscible or non-alloyed blend of polymers typically displays two or more glass transition temperatures associated with immiscible polymer phases. In the simplest cases, the properties of polymer alloys reflect a composition-weighted average of properties possessed by the components. In general, however, the property dependence on composition varies in a complex way with a property, the nature of the components (glassy, rubbery or semi-crystalline), the thermodynamic state of the blend, and its mechanical state whether molecules and phases are oriented.

The primary requirement for the substantially thermoplastic engineering polymer material is that it retains sufficient thermoplastic properties such as viscosity and stability, to permit melt blending with a fiber, permit formation of linear extrudate pellets, and to permit the composition material or pellet to be extruded or injection molded in a conventional thermoplastic process forming the useful product. Engineering polymer and polymer alloys are available from several manufacturers including Dyneon LLC, B.F. Goodrich, G.E., Dow, and duPont.

In another embodiment, laminated or layered interfacially modified glass fibers, fabrics, and/or nonwovens are particularly useful for industrial and structural purposes. In some embodiments, this laminated structure may further comprise other interfacially modified coated fibers, such as calcium silicate fiber. This laminated or layered construction of interfacially modified coated fiber may comprise at least one layer of a woven or non-woven of an interfacially modified glass fabric associated to a second layer comprising a polymer matrix. Such a laminate forms a two-layer construction that is highly resistant to damage caused by impact, twisting or flexing forces. More layers or laminates using said coated fiber and polymer may be formed depending on the application or article requirements.

In another embodiment, the thermoplastic polymer is replaced by thermoplastic composite material. The composite material can comprise generally an IM coated particulate or chopped fiber in combination with polymer. Like the thermoplastic polymer, the composite is applied to the glass fiber layer and is associated with the surface of the interfacially modified coated glass fiber layer. The composite material has thermoplastic characteristics which allows the material to have rheology and performance characteristics of a thermoplastic polymer as previously described.

The completed laminate construction may be pictured as having the interfacially modified glass fiber layer embedded in the thermoplastic polymer. The heat compressed interfacially modified non-woven fibers envelop the thermoplastic polymer and maintain the separation of the glass structure by filling the interstices of the between the interfacially modified fibers.

Other fibers that are useful include, for example, aramid, polyester, nylon, acrylic, metallic or cellulosic fibers. Such fibers are coated with the interfacial modifier prior to making the laminate. The coated fibers may be used in either woven or non-woven construction in combination with a polymer or composite material as previously described.

Polyvinyl chloride resins find particularly utility in formulating an embodiment of the laminate. Phosphate-type and other heat stabilizing plasticizers are incorporated with the PVC resin as well as such stabilizers as calcium zinc complexes, epoxy resins and melamine. When mixed and applied with an effective amount of heat and pressure, this mixture imparts a tough, flexible, coating to the laminated fiber construct. Other resins such as acrylonitrile butadiene styrene (ABS) are also useful in the disclosed embodiments.

Thin layers of the polymer/composites are usually satisfactory for preparing these laminated fiber constructs but, of course, thicker layers can be used when the application or articles requires thicker layers. In function, the layer must be sufficiently thick to effectively keep the fibers together. Typically, single layers thickness is less than a millimeter (greater than about 10 mil) and about 0.1 to 1 min, usually about 0.25 to 0.5 mm. Multiple layer thickness are sums of the single layer thicknesses. The interfacially modified coated fiber is heated at elevated temperatures which are effective for embedding and associating the polymer/composite to the fiber layer. Subjecting the coated fiber to temperatures in the range of 275°-325° F. for 5 minutes or less will normally provide a satisfactory degree of association with the polymer or composite matrix material. One skilled in the art can appreciate that the time and temperature to be used will be dependent upon the fiber and polymer/composite materials being employed and the end-use requirements of the product or article.

A preferred method to prepare the laminate construction of this embodiment is performed in several steps. First the polymer resin or composite formulation is applied to one side of the woven or nonwoven substrate fiber that is coated with interfacial modifier. After applying the polymer in a thin layer to the fiber, the polymer layer and fiber is heated at elevated temperatures of about 300° F. for approximately 3 minutes to embed and associate the formulation to the interfaciaThy modified coated glass fiber. To build multiple layers or laminations of the polymer and fiber, this process can be repeated.

The final step in preparing the laminated glass fiber construction is to subject the layered construction to heat compression of 5 to 15 psi at a temperature of 300°-400° F. for 15-30 seconds. During heat compression, the glass fiber layer is compressed, and the interstices of the glass fiber is enveloped by the polymer or composite material. It is this final step which provides the mechanical properties, such as, for example, high tensile modulus and high impact resistance to be exhibited. In the finished product, the glass fiber is essentially embedded in the polymer or composite material.

Sizing materials used as glass coatings do not act as interfacial modifiers. Sizing is an essential in glass fiber manufacture and critical to certain glass fiber characteristics determining how fibers will be handled during manufacturing and use. Raw fibers are abrasive and easily abraded and reduced in size. Without sizing, fibers can be reduced to useless “fuzz” during processing. Sizing formulations have been used by manufacturers to distinguish their glass products from competitors' glass products. Glass fiber sizing, typically, is a mixture of several chemistries each contributing to sizing performance on the glass fiber surface. Sizings typically are manufactured from film forming compositions and reactive coupling agents. Once formed, the combination of a film forming material and a reactive coupling agent forms a reactively coupled film that is, reactively coupled to the glass fiber surface. The sizing protects the fiber, holding fibers together prior to molding but promote dispersion of the fiber when coming into contact with polymer or resin insuring wet out of glass fiber with resin during composite manufacture. Typically, the coupling agent used with the film forming agent, is a reactive alkoxy silane compound serving primarily to bond the glass fiber to their matrix or film forming resin. Silane typically have a silicon containing group and that bonds well to glass (typically SiO₂) with a reactive organic end that bonds well to film forming polymer resins. Sizings also may contain additional lubricating agents as well as anti-static agents. We have used sized fibers in our studies and found that sizing does not act as interfacial modifier and we can coat all sizing that we have found. While a sizing often contains coupling agents, an IM is free of coupling or reactive coupling agents.

For composites containing high volumetric loading of fibers, the rheological behavior of the highly-packed composites depend on the characteristics of the contact points between the fibers and the distance between fibers. When forming composites with polymeric volumes approximately equal to the excluded volume of the discontinuous phase, inter-fiber interaction dominates the behavior of the material. Fibers contact one another and the combination of interacting sharp edges, soft surfaces (resulting in gouging) and the friction between the surfaces prevent further or optimal packing. Interfacial modifying chemistries can alter the surface of the fiber by Van der Waals forces. The surface of the interfacially modified fiber behaves as a fiber formed of the non-reacted end or non-reacting end of the interfacial modifier. The coating of the interfacial modifier improves the physical association of the fiber and polymer in the formed composite leading to improved physical properties including, but not limited to, increased tensile and flexural strength, increased tensile and flexural modulus, improved notched IZOD impact and reduced coefficient of thermal expansion. In the melt, the interfacial modified coating on the fiber reduces the friction between fibers thereby preventing gouging and allowing for greater freedom of movement between fibers in contrast to fibers that have not been coated with interfacial modifier chemistry. Thus, the composite can be melt-processed at greater productivity and at conditions of reduced temperature and pressure severity. The process and physical property benefits of utilizing the coated fibers in the acceptable fiber morphology index range does not become evident until packing to a significant proportion of the maximum packing fraction. Useful volume % of the fiber phase in the claimed composite can be adjusted to above 40, 50, 60, 70, 80, 90%, 92%, 95%, etc., depending on the end use of the article or structural member and the required physical properties of the article or structural member, without loss of processability via melt-processing, viscoelasticity, rheology, high packing fraction, and fiber surface inertness of the composite.

In a composite, the fiber is usually much stronger and stiffer than the polymer matrix and gives the composite its designed structural or shaped article properties. The matrix holds the fiber in an orderly high-density pattern. Because the fibers are usually discontinuous, the matrix also helps to transfer load among the non-metal, inorganic, synthetic, natural, or mineral fibers. Processing can aid in the mixing and filling of the non-metal, inorganic or mineral fibers. To aid in the mixture, an interfacial modifier can help to overcome the forces that prevent the matrix from forming a substantially continuous phase of the composite. The tunable composite properties arise from the intimate association of the fiber and the polymer obtained using careful polymer processing and manufacture. We believe an interfacial modifier (IM) is an organic material that provides an exterior coating on the fiber promoting the close association of polymer and fiber. Minimal amounts of the interfacial modifier can be used on regular morphology while higher amounts of the IM are used to coat materials with increased or irregular surface morphology. Typically, the composite materials can be manufactured using melt processing and are also utilized in product formation using melt processing such as extrusion, injection molding and the like.

Typically, the composite materials can be manufactured using melt processing and are also utilized in product formation using melt processing. A typical thermoplastic polymer material is combined with IM coated blended fiber and processed until the material attains (e.g.) a uniform density (if density is the characteristic used as a determinant). Once the material attains enough property, such as, for example, density, the material can be extruded into a product or into a raw material in the form of a pellet, chip, wafer, preform or other easily processed material using conventional processing techniques.

In the manufacture of useful products, the manufactured composite can be obtained in appropriate amounts, subjected to heat and pressure, typically in an extruder, or in additive manufacturing useful for 3D printing (additive manufacturing), or injection molding equipment and then formed into an appropriate shape having the correct amount of materials in the appropriate physical configuration. In the appropriate product design, during composite manufacture or during product or article manufacture, a pigment or other dye material can be added to the processing equipment. One advantage of this material is that an inorganic dye or pigment can be co-processed resulting in a material that needs no exterior painting or coating to obtain an attractive, functional, or decorative appearance. The pigments can be included in the polymer blend, can be uniformly distributed throughout the material and can result in a surface that cannot chip, scar or lose its decorative appearance. One particularly important pigment material comprises titanium dioxide (TiO₂). This material is non-toxic, is a bright white particulate that can be easily combined with the fiber and/or polymer composites to enhance the novel characteristics of the composite material and to provide a white hue to the ultimate composite material.

The manufacture of the composite materials depends on good thermoplastic manufacturing technique. The fiber is initially treated with an interfacial modifier by contacting the fiber with the modifier directly or in the form of a solution of interfacial modifier on the fiber with blending and drying carefully to ensure uniform fiber coating. Alternatively, addition of the fiber blend to the twin cone mixers can be followed by drying or direct addition to a screw compounding device. Interfacial modifiers may also be combined with the fiber blend in aprotic solvent such as toluene, tetrahydrofuran, mineral spirits or other such known solvents.

The fiber blend can be combined into the polymer phase depending on the nature of the polymer phase, the filler, the fiber surface chemistry and any pigment process aid or additive present in the composite material. The composite materials having the desired physical properties can be manufactured as follows. In an embodiment, the surface of the fiber is initially prepared, the interfacial modifier coats the fiber, and the resulting product is isolated and then combined with the continuous polymer phase to affect an immiscible dispersion or association between the fiber and the polymer. Once the composite material is compounded or prepared, it is then melt-processed into the desired shape of the end use article.

Solution processing is an alternative that provides solvent recovery during materials processing. The materials can also be dry-blended without solvent. Blending systems such as ribbon blenders obtained from Drais Systems, high-density drive blenders available from Littleford Brothers and Henschel are possible. Further melt blending using Banberry, other single screw or twin-screw compounders is also useful. When the materials are processed as a plastisol or organosol with solvent, liquid ingredients are generally charged to a processing unit first, followed by polymer, fiber and rapid agitation. Once all materials are added a vacuum can be applied to remove residual air and solvent, and mixing is continued until the product is uniform and high in density.

Dry blending fiber with polymer is generally preferred due to advantages in cost. However certain embodiments can be compositionally unstable due to differences in fiber size. In dry blending processes, the composite can be made by first introducing the polymer, combining the polymer stabilizers, if necessary, at a temperature from about ambient to about 60° C. with the polymer, blending a fiber (IM modified) with the stabilized polymer, blending other process aids, interfacial modifier, colorants, indicators or lubricants followed by mixing in hot mix, transfer to storage, packaging or end use manufacture. Fiber materials can be obtained or produced on site. Interfacially modified materials can be made with solvent techniques that use an effective amount of solvent to initiate formation of a composite.

Interfacially modified materials can be made by direct contact of fiber with IM or with solvent techniques that use an effective amount of solvent to initiate formation of a composite. When interfacially modification is substantially complete, the solvent can be stripped. Such solvent processes are conducted by solvating the interfacial modifier or polymer or both; mixing a glass fiber with interfacial modifier into a bulk phase or polymer master batch and devolatilizing the composition in the presence of heat & vacuum above the Tg of the polymer.

When compounding with twin screw compounders or extruders, a process can be used employing twin screw compounding can be described as adding the IM coated glass fiber and raise temperature to remove surface water; venting reaction by-products and adding polymer; compressing and/or melting polymer; dispersing or distributing glass fiber in polymer; degassing remaining reaction products; compressing resulting glass fiber and polymer composite and forming the desired shape, pellet, lineal, tube, injection mold article, etc. through a die or post-manufacturing step.

For alternative formulations containing small volumes, a process can be the following: adding interfacial modifier to fiber; combining coated fiber in a twin screw when polymer is at temperature; dispersing or distributing interfacial modified fiber in the polymer; adjusting the temperature to initiate extrusion; maintaining temperature to completion; and forming desired shape, pellet, lineal, tube, injection mold article, etc. through a die or post-manufacturing step.

In another embodiment for formulations of glass fiber, a process could be adding polymer; raising the temperature of the polymer to a melt state; adding glass fiber which has been pre-treated with the interfacial modifier; dispersing and distributing glass fiber in the polymer; compressing the resulting glass fiber and polymer composite; and forming the desired shape, pellet, lineal, tube, injection mold article, etc. through a die or post-manufacturing step.

The composite can be used to make a pellet. Such a pellet made of the composite can be used as an intermediate between the compounding of the composite and the manufacturing of the final product. Such a pellet can comprise the composite comprising the components in use concentration of components designed to be directly converted or used in making a useful article. Alternatively, the pellet can comprise a master batch composition with increased amounts, e.g., about 2 to 10 times the amount of fiber such that the pellet can be combined with polymer in proportions that result in producing use concentrations. The pellet is a roughly cylindrical object that can be fed into an extruder input. The pellet is typically 1 to 10 mm in height and 1 to 10 mm in diameter.

The composite can be used to make an article of manufacture. Such articles can be made directly from the compounding process or can be made from a pellet input. Articles can include pellets used in further thermoplastic processing, structural members, or other articles that can be made using thermoplastic processing such as injection molding, compression molding, etc.

Structural members include linear extrudates that can be mechanically milled or reinforced with secondary members. The articles can be used in a fenestration unit as a frame member, muntin, grill etc. The articles can be used in a decking installation as a decking member, a trim, or a support. The article can be used as a rail, baluster or post. The article can be used as a siding member. The articles can be used as a ladder.

The interior of the structural member is commonly provided with one or more structural webs which in a direction of applied stress supports the structure. Structural web typically comprises a wall, post, support member, or other formed structural element which increases compressive strength, torsion strength, or other structural or mechanical properties. Such structural web connects the adjacent or opposing surfaces of the interior of the structural member. More than one structural web can be placed to carry stress from surface to surface at the locations of the application of stress to protect the structural member from crushing, torsional failure or general breakage. Typically, such support webs are extruded, or injection molded during the manufacture of the structural material. However, a support can be post added from parts made during separate manufacturing operations.

The internal space of the structural member can also contain a fastener anchor or fastener installation support. Such an anchor or support means provides a locus for the introduction of a screw, nail, bolt or other fastener used in either assembling the unit or anchoring the unit to a rough opening in the commercial or residential structure. The anchor web typically is conformed to adapt itself to the geometry of the anchor and can simply comprise an angular opening in a formed composite structure, can comprise opposing surfaces having a gap or valley approximately equal to the screw thickness, can be geometrically formed to match a key or other lock mechanism, or can take the form of any commonly available automatic fastener means available to the window manufacturer from fastener or anchor parts manufactured by companies such as Amerock Corp., Illinois Tool Works and others.

The structural member can have extrusion molded, premolded paths or paths machined into the molded thermoplastic composite for passage of door or window units, fasteners such as screws, nails, etc. Such paths can be counter sunk, metal lined, or otherwise adapted to the geometry orthe composition of the fastener materials. The structural member can have mating surfaces formed to provide rapid assembly with other window components. Components of similar or different compositions having similarly adapted mating surfaces. Further, the structural member can have mating surfaces formed in the shell of the structural member adapted to moveable window sash or door sash or other moveable parts used in window operations.

The structural member can have a mating surface adapted for the attachment of the subfloor or base, framing studs or side molding or beam, top portion of the structural member to the rough opening. Such a mating surface can be flat or can have a geometry designed to permit easy installation, sufficient support and attachment to the rough opening. The structural member shell can have other surfaces adapted to an exterior trim and interior mating with wood trim pieces and other surfaces formed into the exposed sides of the structural member adapted to the installation of metal runners, wood trim parts, door runner supports, or other metal, plastic, or wood members commonly used in the assembly of windows and doors.

The assembly can use known fastener techniques. Such techniques include screws, nails, and other hardware. The structural members can also be joined by an insert into the hollow profile, glue, or a melt fusing technique wherein a fused weld is formed at a joint between two structural members. The structural members can be cut or milled to form conventional mating surfaces including 90° angle joints, rabbit joints, tongue and groove joints, butt joints, etc. Such joints can be bonded using an insert placed into the hollow profile that is hidden when joinery is complete. Such an insert can be glued or thermally welded into place. The insert can be injection molded or formed from similar thermoplastics and can have a service adapted for compression fitting and secure attachment to the structural member. Such an insert can project from approximately 1 to 5 inches into the hollow interior of the structural member. The insert can be shaped to form a 90° angle, a 180° extension, or other acute or obtuse angle required in the assembly of the structural member.

Further, such members can be manufactured by milling the mating faces and gluing members together with a solvent, structural or hot melt adhesive. Solvent borne adhesives that can act to dissolve or soften thermoplastic present in the structural member and to promote solvent based adhesion or welding of the materials are known in polyvinyl chloride technology. In the welding technique, once the joint surfaces are formed, the surfaces of the joint can be heated to a temperature above the melting point of the composite material and while hot, the mating surfaces can be contacted in a configuration required in the assembled structure. The contacted heated surfaces fuse through an intimate mixing of molten thermoplastic from each surface. Once mixed, the materials cool to form a structural joint having strength typically greater than joinery made with conventional techniques. Any excess thermoplastic melt that is forced from the joint area by pressure in assembling the surfaces can be removed using a heated surface, mechanical routing or a precision knife cutter.

In the manufacture of structural articles in which a vertical member is joined with a horizontal member such as in a step or extension ladder, the horizontal members must be fastened securely to the vertical members to avoid failure and the resulting damage or injury to users. In conventional structures such as step and extension ladders, the vertical rails are commonly attached to the horizontal steps using mechanical rivets and associated braces such as a gusset or angled metal reinforcing member. Such riveted structures have a failure mode resulting from the concentration of forces that become point loaded in the area around the rivets in the aperture through which the rivet is placed.

The area exposed to this force is relatively small and as a result even normal day-to-day use can slowly cause the area surrounding the aperture to fail. More problematically, however, the more aggressive or abusive use of such structures can cause a rapid failure of the riveted structure due to the higher point loading of stresses at the rivet aperture. The structure, further, requires additional parts and assembly time due to the need for reinforcing structures with respect to the riveted step. Such added members in the structures increase strength but also reduce the tendency of the ladder to “rack.” Further these structures increase the total weight of the ladder.

A substantial need exists in such structural articles to form a joint between the horizontal members and the vertical members that distribute the stress of the assembly over a larger area thus reducing the tendency of the join to fail under both normal and abusive conditions. Further a substantial need exists for a simpler manufacturing technique involving fewer parts and less assembly steps that result in a quality ladder without such expense. Lastly the goal of any structural article that is assembled in this fashion with horizontal members fastened to vertical members the reduction and weight of the overall structure is a highly sought-after result.

All these needs are met by forming both the vertical members and the horizontal members from a thermoplastic composite material that is then generically welded at the contact areas between the vertical and horizontal members such that the welded joint between the members is coextensive with the substantially entire overlap between the horizontal member and the vertical member. Since the entire area of overlap is fused between the members, the forces of the normal and abusive use, are distributed over a larger area than the conventional rivet joint, thus reducing stress among the members. Further the large area of the joint is rigid and can more reliably reduce racking in the assembled structure. Lastly the use of these composite materials reduces weight but also, because of the increased strength in the joint, the geometry of the ladder can be modified reducing weight in the final assembly.

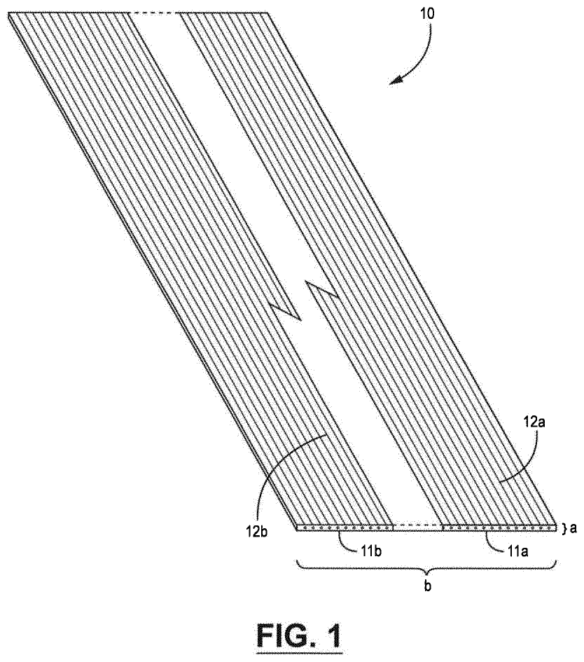

In one embodiment of the welded structure as claimed, a rail, a vertical member, is assembled with a step, horizontal member, and a second rail with a plurality of other steps formed there between. These members are positioned at a 90° angle with respect to one another and are then welded at the entire interface between the rail and the step such that there is a fused, melted or thermoplastically molten joint therebetween. The welded area of the joint is a minimum of about 25 cm², 30 cm², 40 cm², or more. In a step and rail assembly, the joint overall structure must withstand a total force of about 4500 newtons (N) (1000 lbs. force) 2750 newtons (N) (500 lbs. force) per weld. In a ladder the structure must pass the ANSI 14-5, sec. 8.5.3 standard. This embodiment uses a useful profile for both the rail and the step is a “C-channel”. The C-channel profile can be seen in FIG. 5 of the specification. In this embodiment, the horizontal and vertical members are formed as a C-channel comprising a composite material formed as a laminate of layers in which each layer comprises a thermoplastic phase in which reinforcing fibers are dispersed as a discontinuous phase within the continuous polymer phase. Such fibers can either be a random distribution of chopped fibers or lengths of glass fibers having an indeterminate length formed in the thermoplastic phase as parallel fibers as shown in FIG. 1-4.

Such composite laminates can be formed into a C-channel structure. A C-channel type structure can be used as a rail or as a step. The dimensions of the rail and the step are not necessarily identical but can be engineered for optimizing the structural characteristic of the assembled unit. Such a composite can be made from typical thermoplastic materials that can be made to be compatible with the included fiber material. In the manufacture of extension and step ladders, the fiber is commonly a glass fiber while the polymer phase can compromise a variety of both vinyl and condensation polymers. In the claimed materials, we have found that the interfacial modifier coating on the glass fibers obtains a substantially improved composite layer and resulting laminate material overall. As can be seen in FIG. 5, a C-channel is inserted as a step into a C-channel as a rail. The step is positioned within the rail to be horizontal step in use. Its position creates an overlapping area wherein the substantial area of both the rail and the step are in intimate contact for welding.

A source of thermal energy is then contacted at the overlapping area causing the thermoplastic within the step and the rail to become melted. The joint is formed as the melted thermoplastic becomes intimately associated and after cooling forms a rigid structural attachment. Virtually any method of forming a thermoplastically welded joint can be used in the assembly of the claimed structures. Such processes include, for example, ultrasonic welding, heat welding or vibratory welding. Heat welding generally involves the direct application of heat to one or both sides of the positioned C-channels such that the heat melts at least a portion of the thermoplastic polymer in the composite forming the joint. Ultrasonic welding occurs by the application of high frequency sound in a direction normal to the mated surfaces that causes the thermoplastic polymer and the members to heat and join. Vibratory welding operates by contacting the surface of a horizontal member and a vertical member at the interface and causing a vibration where the horizontal member moves its surface parallel to that of the vertical member and at the motion causes frictional heating at the surfaces in contact such that the surfaces form a melted layer which then can fuse and join the horizontal to the vertical member.

TABLE 1
Exemplary Composites

| | Useful | Useful | Useful |
|---|---|---|---|
| Component | amounts | amounts | amounts |
| Glass fiber | 5-95 | 10-90 | 15-85 |
| (vol. %) | | | |
| Second fiber | 0-60 | 0-50 | 10-45 |
| (vol. %) | | | |
| Glass fiber | 5-95 | 10-90 | 15-85 |
| (wt. %) | | | |
| Second fiber | 0-75 | 0-70 | 20-65 |
| (wt. %) | | | |
| IM | 0.1-5 | 0.3-3 | 0.5-2.5 |
| (Vol. %) | | | |
| IM | 0.1-2 | 0.2-1 | 0.3-0.8 |
| (Wt. %) | | | |
| Thermoplastic | 45-95 | 50-92 | 55-90 |
| polymer | | | |
| (vol. %) | | | |
| Thermoplastic | 20-90 | 30-85 | 35-80 |
| polymer | | | |
| (wt. %) | | | |

Additionally, the use of the IM permits an increase in the fiber loading in the composite. As the fiber content increases, the polymer content decreases. The thermal expansion of a structural member made with the disclosed material will be improved as fiber content increases, e.g., the material will have reduced coefficient of thermal expansion (COTE).

### EXPERIMENTAL SECTION EXAMPLES AND DATA

### Example 1

A single layer composite is made by spreading a glass fiber, yarn, or roving through a sinusoidal path to spread the fibers in a uniform spacing in an appropriate width. The fiber input typically has 1,000 to 10,000 fibers, which can be conveniently spread using spaced stainless-steel bars of the appropriate diameter. The ratio of PVC to fiber is about 65-58/40-42 weight percent with an interfacial modifier coating on the fiber, rovings of 0.25-2 weight percent. The polymer and fibers are extruded in a cross-head extruder, is cooled and formed into a composite layer.

### Example 2

A single layer composite is made by spreading a glass fiber, yarn, or roving through a sinusoidal path to spread the fibers in a uniform spacing in an appropriate width. The fiber input typically has 1,000 to 10,000 fibers, which can be conveniently spread using spaced stainless-steel bars of the appropriate diameter. The ratio of PVC to fiber is about 65-58/40-42 weight percent with an interfacial modifier coating on the fiber, rovings of 0.25-2 weight percent. Polymer is in the form of a water dispersion. The dispersion is coated onto the fiber. The wet coating is dried on the glass fiber and then fused and cooled.

### Example 3

A single layer composite is made by spreading a glass fiber, yarn, or roving through a sinusoidal path to spread the fibers in a uniform spacing in an appropriate width. The fiber input typically has 1,000 to 10,000 fibers, which can be conveniently spread using spaced stainless-steel bars of the appropriate diameter. The ratio of PVC to fiber is about 65-58/40-42 weight percent with an interfacial modifier coating on the fiber, rovings of 0.25-2 weight percent. the glass roving distribution is a distribution of substantially parallel fibers are sandwiched between two polyvinyl chloride sheet layers, which are then heated and fused into a single layer tape with the glass embedded into the polyvinyl chloride fused sheets.

### Example 4

A laminate is made by combining a layer of the composite of Example 1 and a second layer of the composite of Example 1 wherein the fibers in each layer are positioned at substantially right angles.

### Example 5

A laminate is made by combining a layer of the composite of Example 1 and a second layer of the composite of Example 1 with a layer of a composite comprising a dispersion of chopped interfacially modified fiber dispersed in a polymer wherein the fibers in each layer of Example 1 are positioned at substantially right angles.

### Example 6

Welded ladders made from the laminate of Example 1 were tested for tensile pulling after straightening the rail.

| | Width | Length | Force | Shear Stress |
|---|---|---|---|---|
| Weld Type | (in) | (in) | (lbs) | (psi) |
| Solvent | 1.23 | 0.967 | 942 | 792 |
| Solvent | 1.394 | 0.983 | 1100 | 803 |
| Vibrational | 1.22 | 0.72 | 1361 | 1550 |
| Vibrational | 1.25 | 0.92 | 1930 | 1679 |

For the vibrational testing, the weld was made with an amplitude of 3.8 mm, 100 Hz, ˜4 bar clamping pressure and 6 seconds of weld time. The machine used was a Telsonic 930a.

### DETAILED DESCRIPTION OF THE DRAWINGS

FIG. 1 is a cross sectional view of an extruded layer. The layer 10 includes a polymer 11a, 11b and a fiber 12a, 12b. Dimensions a and b are such that b>>a. The layer can be greater than 0.2 mm and 0.5 to 5 mm in thickness and can be at least 1 cm and 5 to 20 cm in width.

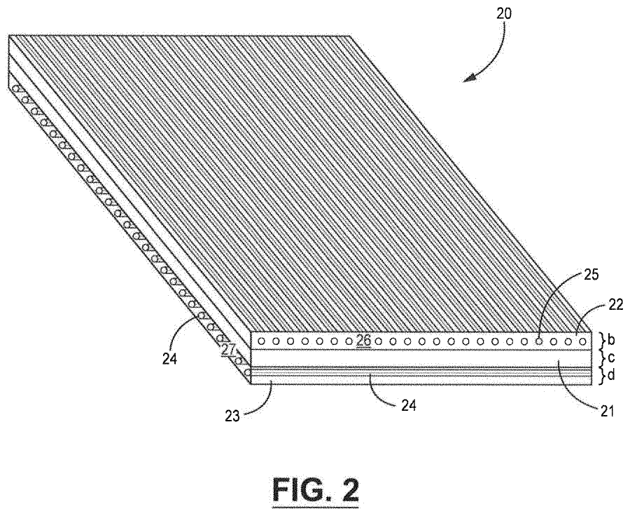

FIG. 2 is an isometric view of one embodiment of a structure containing three layers. In the structure 20 is a central layer 21 that can be a polymer layer or any composite type such as a chopped fiber in a polymer. On opposite sides of the layer 21, is a layer 26, 27 of fiber 24, 25 and polymer 22, 23. The indicia b, c, d relate to thicknesses that can range independently from 0.3 to 1 mm.

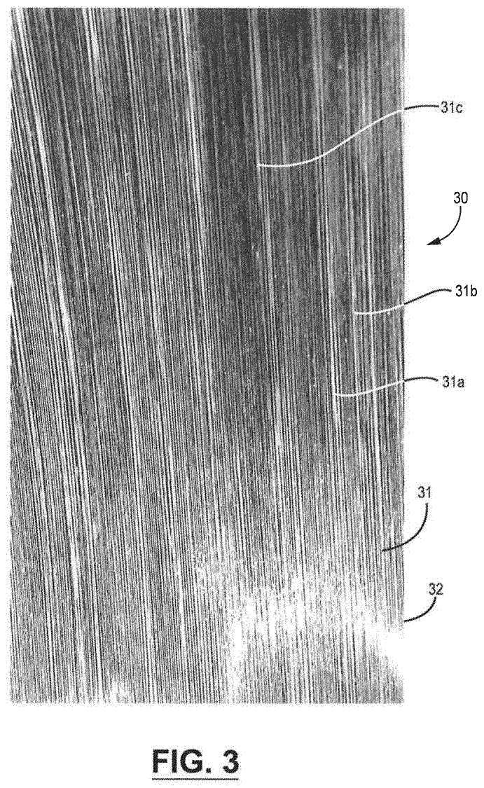

FIG. 3 is a plan view of a photograph of a portion of an extruded layer of a polymer and indeterminately long and parallel glass fibers embedded therein. The layer 30 is made of a continuous extruded portion of a polymer 32 with a plurality of parallel and continuous glass fibers 31, 31a, 31b fully contained and covered therein. The polymer 32 is substantially transparent and the embedded fibers can be readily seen.

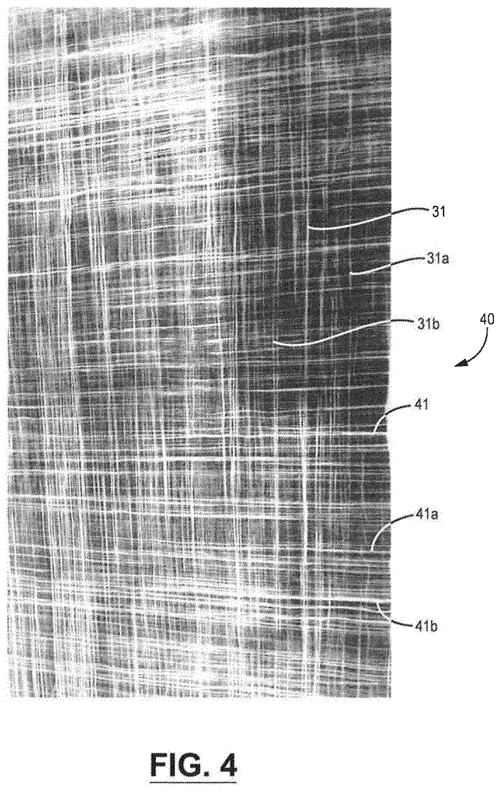

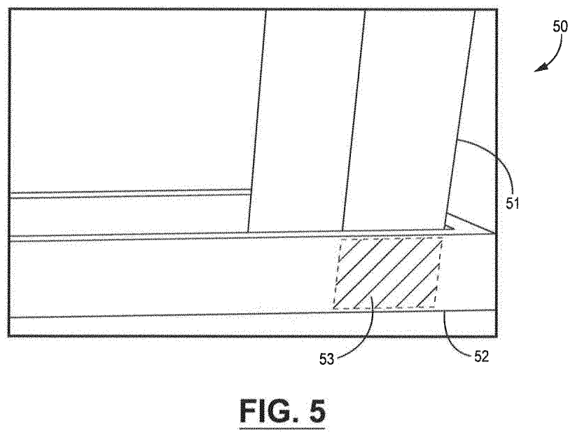

FIG. 4 is a plan view of a photograph of a portion of an article comprising two laminated layers of an extruded layer like that of FIG. 3. The polymer in each layer is substantially transparent and the embedded fibers 31 31a 31b and 41 41a 41b can be readily seen.

FIG. 5 is a view of an assembly 50 of a horizontal step 51 and a vertical rail 52. The overlapping area 53 between the rail and the step can be thermally fused forming a rigid joint. The step 51 and the rail 52 are both shown as c-channel structures.

TABLE 4
Figures and reference numbering

| Element | Reference numbering | Explanation |
|---|---|---|
| FIG. 1 | Single layer extrudate | |
| Profile/member | 10 | Extrudate layer of |
| | | parallel fibers and |
| | | polymer |
| Polymer | 11a b | Continuous phase |
| | | surrounding fibers |
| Fiber | 12a b | Parallel fibers |
| a b | Width and length | b >> a |
| FIG. 2 | Embodiment is a | A laminate of at |
| | three-layer laminate | least two of |
| | | disclosed fiber |
| | | composited and a |
| | | third generic layer |
| Profile/member | 20 | Laminate |
| | 21 | Generic |
| | | polymer/composite |
| | | layer |
| | 22 | Polymer |
| | 23 | Polymer |
| | 24 | Fiber |
| | 25 | Fiber |
| | 26 | Single layer |
| | 27 | Single layer |
| b c d | Thickness of layer | |
| FIG. 3 | Single layer extrudate | |
| Extruded layer | 30 | Single layer |
| Fibers | 31 31a 31b | Parallel fibers |
| Polymer | 32 | Continuous |
| | | polymer phase |
| FIG. 4 | Laminate of at least | |
| | two FIG. 3 extrudates | |
| Laminate of at least | 40 | Combined single |
| two layers | | layers with fibers |
| | | at 90° angle |
| Parallel fibers | 31 31a 31b | Machine direction |
| | | orientation |
| Parallel fibers | 41 41a 41b | Cross machine |
| | | direction |
| | | orientation |
| FIG. 5 | 50 | Assembly Article |
| Horizontal step | 51 | C-channel |
| Vertical rail | 52 | C-channel |
| Overlap area | 53 | Welded area |

The claims may suitably comprise, consist of, or consist essentially of, or be substantially free or free of any of the disclosed or recited elements. The claimed technology is illustratively disclosed herein can also be suitably practiced in the absence of any element which is not specifically disclosed herein. The various embodiments described above are provided by way of illustration only and should not be construed to limit the claims attached hereto. Various modifications and changes may be made without following the example embodiments and applications illustrated and described herein, and without departing from the true spirit and scope of the following claims. While the above specification shows an enabling disclosure of the composite technology, other embodiments may be made with the claimed materials. Accordingly, the invention is embodied solely in the claims hereinafter appended.

1. A laminate composite comprising at least two layers, each layer comprising interfacially modified fibers in a layer that is a horizontal and substantially uniform distribution of substantially parallel separated fibers in a polymeric layer, each layer independently positioned at a substantially 90° angle, and the coated fibers of the laminate composite has greater freedom of movement between the fibers than fibers not coated with the interfacial modifier.

2. The laminate composite of claim 1 that comprises a third layer comprising a polymer film.

3. The laminate composite of claim 1 that comprises a composite of a particulate or a chopped fiber and a polymer.

4. The laminate composite of claim 1 wherein the fibers comprises about 0.01 to 6 wt. % of an interfacial modifier.

5. The laminate composite of claim 1 wherein the thickness of the laminate is greater than about 0.25 mm.

6. The laminate composite of claim 1 wherein the fibers comprise natural or synthetic fibers.

7. The laminate composite of claim 1 wherein the fibers comprise a glass or carbon.

8. The laminate composite of claim 1 wherein the fibers comprise a cellulosic fiber or flax.

9. The laminate composite of claim 1 wherein the layer comprises about 90 to 40 weight-% of fibers

10. The laminate composite of claim 1 wherein the polymer comprises a polyvinylchloride homopolymer with a K value about 50-75 (ISO 1628-2).

11. The laminate composite of claim 1 wherein the organometallic interfacial modifier comprises a titanate compound.

12. The laminate composite of claim 1 wherein the interfacially modified fibers have an exterior coating comprising a continuous layer having a thickness of about 100 to 1500 Å.

13. The laminate composite of claim 1 wherein the organometallic interfacial modifier is free of a reactive coupling agent.

14. The laminate composite of claim 1 wherein the wherein the composite is free of an epoxy or a silane reactive coupling agent.

15. A shaped article comprising the laminate composite of claim 1.

16. A single layer composite comprising an interfacially modified fiber layer that is a horizontal and substantially uniform distribution of substantially parallel separated fibers in a polymeric layer, and the coated fibers of the laminate composite has greater freedom of movement between the fibers than fibers not coated with the interfacial modifier.

17. An assembly comprising at least two parallel horizontal C-channel thermoplastic composite members and at least two parallel vertical C-channel thermoplastic composite members spaced apart and positioned at right angles, such that an area of overlap is formed at the interface between each horizontal and vertical member, wherein the area of overlap comprises a joint formed from melted portions of the overlap.

18. The assembly of claim 17 wherein the members comprise the laminate composite of claim 1.

19. The assembly of claim 17 wherein the joint is vibratory welded.
